(19) United States
(12) Patent Application Publication
(10) Pub. No.: US 2026/0109606 A1
(43) Pub. Date: Apr. 23, 2026

(54) RAPID AND NON-DESTRUCTIVE IN-SITU FORMATION OF NITROGEN-DOPED CARBON NANOMATERIALS AND THE METHODS OF PRODUCTION THEREOF

(71) Applicant: Trimtabs Ltd, Swansea (GB)

(72) Inventors: Alvin ORBAEK WHITE, Swansea (GB); Thomas Alexander MAHY, Bridgend (GB); Ioannis TSAMPANAKIS, Bridgend (GB)

(21) Appl. No.: 19/362,279

(22) Filed: Oct. 17, 2025

Related U.S. Application Data
(60) Provisional application No. 63/709,278, filed on Oct. 18, 2024.

(51) Int. Cl. C01B 32/168

(52) U.S. Cl. CPC C01B 32/168; C01B 2202/06; C01B 2202/34; C01B 2202/36; C01P 2002/82; C01P 2002/88; C01P 2004/03; C01P 2004/04; C01P 2004/54

(57) ABSTRACT

Embodiments of the present disclosure generally relate to methods of producing carbon-nitrogen allotrope nanomaterials. More specifically, the methods of the present disclosure utilize nitrogen-containing compounds as a feedstock for nitrogen doped carbon nanomaterial production. In some embodiments, a method for forming carbon-nitrogen nanomaterials includes mixing a nitrogen-rich feedstock, carbon-based feedstock, and a catalyst to form a feed solution. The method further includes injecting the feed solution into a carrier gas stream and into a heated reaction vessel. The heated reaction vessel includes a first zone and a second zone. The method further includes heating the feed solution within the first zone at a first temperature. The method further includes heating the feed solution within the second zone at a second temperature to form the carbon-nitrogen nanomaterials. The method further includes removing the carbon-nitrogen nanomaterials from the heated reaction vessel.

### CROSS-REFERENCE TO RELATED APPLICATIONS

This application claims benefit of and priority to U.S. Provisional Application No. 63/709,278, filed Oct. 18, 2024, which is herein incorporated by reference in its entirety.

### BACKGROUND

### Field

Embodiments of the present disclosure generally relate to methods of producing nitrogen-doped carbon nanotubes allotrope nanomaterials. More specifically, the methods of the present disclosure utilize nitrogen-containing compounds as a feedstock for nitrogen doped carbon nanomaterial production.

### Description of the Related Art

Carbon nanotubes represent a broad category of materials characterized by their tubular structure. These compounds exhibit malleability, allowing them to be molded and pressed into various shapes according to the specific application requirements. Carbon nanotubes are regarded as both inorganic and organic polymer-like materials, typically possessing high molecular mass. They often feature end-caps, which can take the form of Buckminsterfullerene or may contain residual catalyst material from their formation process. Typically synthetic, carbon nanotubes are derived from petrochemicals, plastics, and other carbon-based materials.

A variety of carbon allotropes in nanomaterials include graphene, multi-walled carbon nanotubes (MWCNTs), single-walled carbon nanotubes (SWCNTs), and Buckminsterfullerene. Both SWCNTs and MWCNTs are cylindrical materials characterized by an unbroken crystallographic lattice extending throughout the length of the tubes.

A challenge with traditional carbon nanotubes, composed solely of carbon, is the high energy requirement for attaching functional molecules to their sidewalls, a process known as sidewall functionalization. Sidewall functionalization is typically necessary for producing strong composite materials, which represent one of the largest applications of carbon nanotubes. The use of nitrogen doped carbon nanotubes (NCNTs) can enhance and simplify this process. Nitrogen doping increases the electron density on the carbon nanotube surfaces, facilitating the addition of functional groups and, consequently, the production of composite materials. Additionally, the increased electron density renders the CNT surfaces more suitable for catalytic reactions.

The utilization of nitrogen-doped carbon nanotubes and nitrogen-doped carbon nanomaterials is currently limited, primarily due to their limited commercial availability and high cost. Despite this, these materials exhibit exceptional stability and hold potential for a broad range of applications. They offer numerous advantages over traditional materials such as copper, aluminum, and material blends. However, forming them into macro-scale objects, like wires and cables, poses challenges, as they do not naturally adhere to form strong structures. Consequently, carbon nanomaterials must be mixed or blended with resins and other interstitial media to provide mechanical strength. The selection of additives can affect the strength and electrical conductivity of the resulting cable. Nonetheless, in this blended form, the charge-carrying capacity is reduced compared to the raw nanomaterial, diminishing their effectiveness as electrical wires relative to traditional materials like copper, aluminum, or metal blends used in electrical transmission.

A drawback of the prior art for synthesizing nitrogen doped CNTs material is that it requires a multi-step process involving destroying pristine nanomaterials to incorporate nitrogen into the chemical structure.

Thus, there is a need to develop new synthetic pathways and/or strategies to prepare nitrogen doped CNTs.

### SUMMARY

Embodiments of the present disclosure generally relate to methods of producing nitrogen-doped carbon allotrope nanomaterials. More specifically, the methods of the present disclosure utilize nitrogen-containing compounds as a feedstock for nitrogen doped carbon nanomaterial production.

In some embodiments, a method for forming nitrogen-doped carbon nanomaterials includes mixing a nitrogen-rich feedstock, carbon-based feedstock, and a catalyst to form a feed solution. The method further includes injecting the feed solution into a carrier gas stream and into a heated reaction vessel. The heated reaction vessel includes a first zone and a second zone. The method further includes heating the feed solution within the first zone at a first temperature. The method further includes heating the feed solution within the second zone at a second temperature to form the carbon-nitrogen nanomaterials. The method further includes removing the nitrogen-doped carbon nanomaterials from the heated reaction vessel.

In some embodiments, a method for forming a nitrogen-doped carbon nanomaterial includes mixing a nitrogen-rich feedstock, carbon-based feedstock, and a catalyst to form a feed solution. The feed solution is made up of about 0.01 wt % to about 20 wt % of the nitrogen-rich feedstock. The method further includes injecting the feed solution into a carrier gas stream, and into a heated reaction vessel. The heated reaction vessel includes a first zone and a second zone. The carrier gas stream includes a mixture of hydrogen and nitrogen in a molar ratio of about 0.1:1 to about 1:0.1. The method further includes heating the feed solution within the first zone at a first temperature. The method further includes heating the feed solution within the second zone at a second temperature to form the nitrogen-doped carbon nanotubes nanomaterials. The method further includes removing the nitrogen-doped carbon nanomaterial from the heated reaction vessel.

In some embodiments, a continuous reaction method for forming nitrogen-doped carbon nanomaterials includes mixing a nitrogen-rich feedstock, carbon-based feedstock, and a catalyst to form a feed solution. The feed solution includes about 0.01 wt % to about 20 wt % of the nitrogen-rich feedstock. The feed solution is substantially free of solvent. The method further includes injecting the feed solution into a carrier gas stream, and into a heated reaction vessel. The heated reaction vessel includes a first zone and a second zone. The method further includes heating the feed solution within the first zone at a first temperature. The method further includes heating the feed solution within the second zone at a second temperature to form the nitrogen-doped carbon nanomaterials. The method further includes removing the nitrogen-doped carbon nanomaterials from the heated reaction vessel.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a schematic of a reaction vessel, according to an embodiment.

FIG. 2A shows a scanning electron microscope image (SEM) of a nitrogen-doped carbon nanomaterial, according to an embodiment.

FIG. 2B shows a scanning electron microscope image (SEM) of a nitrogen-doped carbon nanomaterial, according to an embodiment.

FIG. 2C shows a scanning electron microscope image (SEM) of a nitrogen-doped carbon nanomaterial, according to an embodiment.

FIG. 3A shows a transmission electron microscope image (TEM) of a nitrogen-doped carbon nanomaterial, according to an embodiment.

FIG. 3B shows a transmission electron microscope image (TEM) of a nitrogen-doped carbon nanomaterial, according to an embodiment.

FIG. 3C shows a transmission electron microscope image (TEM) of a nitrogen-doped carbon nanomaterial, according to an embodiment.

FIG. 4A shows a transmission electron microscope image (TEM) of a nitrogen-doped carbon nanomaterial, according to an embodiment.

FIG. 4B shows a transmission electron microscope image (TEM) of a nitrogen-doped carbon nanomaterial, according to an embodiment.

FIG. 4C shows a transmission electron microscope image (TEM) of a nitrogen-doped carbon nanomaterial, according to an embodiment.

FIG. 5A shows a transmission electron microscope image (TEM) of a nitrogen-doped carbon nanomaterial, according to an embodiment.

FIG. 5B shows a transmission electron microscope image (TEM) of a nitrogen-doped carbon nanomaterial, according to an embodiment.

FIG. 5C shows a transmission electron microscope image (TEM) of a nitrogen-doped carbon nanomaterial, according to an embodiment.

FIG. 6A illustrates various intensity ratio peaks of a nitrogen-doped carbon nanomaterial as determined by Raman spectroscopy, according to an embodiment.

FIG. 6B illustrates various intensity ratio peaks of a nitrogen-doped carbon nanomaterial as determined by Raman spectroscopy, according to an embodiment.

FIG. 7A illustrates a Raman spectra of a nitrogen-doped carbon nanomaterial, according to an embodiment.

FIG. 7B illustrates a Raman spectra of a nitrogen-doped carbon nanomaterial, according to an embodiment.

FIG. 7C illustrates a Raman spectra of a nitrogen-doped carbon nanomaterial, according to an embodiment.

FIG. 7D illustrates a Raman spectra of a nitrogen-doped carbon nanomaterial, according to an embodiment.

FIG. 8A illustrates a deconvoluted Raman spectra of a nitrogen-doped carbon nanomaterial, according to an embodiment.

FIG. 8B illustrates a deconvoluted Raman spectra of a nitrogen-doped carbon nanomaterial, according to an embodiment.

FIG. 8C illustrates a deconvoluted Raman spectra of a nitrogen-doped carbon nanomaterial, according to an embodiment.

FIG. 8D illustrates a deconvoluted Raman spectra of a nitrogen-doped carbon nanomaterial, according to an embodiment.

FIG. 8E illustrates a deconvoluted Raman spectra of a nitrogen-doped carbon nanomaterial, according to an embodiment.

FIG. 8F illustrates a deconvoluted Raman spectra of a nitrogen-doped carbon nanomaterial, according to an embodiment.

FIG. 9A illustrates a thermogravimetric analysis (TGA) thermogram of nitrogen-doped carbon nanomaterials, according to an embodiment.

FIG. 9B illustrates a thermogravimetric analysis (TGA) thermogram of nitrogen-doped carbon nanomaterials, according to an embodiment.

FIG. 10A shows a transmission electron microscope image (TEM) of a nitrogen-doped carbon nanomaterial, according to an embodiment.

FIG. 10B shows a transmission electron microscope image (TEM) of a nitrogen-doped carbon nanomaterial, according to an embodiment.

FIG. 10C shows a transmission electron microscope image (TEM) of a nitrogen-doped carbon nanomaterial, according to an embodiment.

FIG. 11A shows a transmission electron microscope image (TEM) of a nitrogen-doped carbon nanomaterial, according to an embodiment.

FIG. 11B shows a transmission electron microscope image (TEM) of a nitrogen-doped carbon nanomaterial, according to an embodiment.

FIG. 11C shows a transmission electron microscope image (TEM) of a nitrogen-doped carbon nanomaterial, according to an embodiment.

FIG. 12A shows a transmission electron microscope image (TEM) of a nitrogen-doped carbon nanomaterial, according to an embodiment.

FIG. 12B shows a transmission electron microscope image (TEM) of a nitrogen-doped carbon nanomaterial, according to an embodiment.

FIG. 12C shows a transmission electron microscope image (TEM) of a nitrogen-doped carbon nanomaterial, according to an embodiment.

FIG. 13A illustrates a Raman spectra of a nitrogen-doped carbon nanomaterial, according to an embodiment.

FIG. 13B illustrates a Raman spectra of a nitrogen-doped carbon nanomaterial, according to an embodiment.

FIG. 13C illustrates a Raman spectra of a nitrogen-doped carbon nanomaterial, according to an embodiment.

FIG. 13D illustrates a Raman spectra of a nitrogen-doped carbon nanomaterial, according to an embodiment.

FIG. 14 illustrates a Raman spectra of a nitrogen-doped carbon nanomaterial, according to an embodiment.

FIG. 15 shows a scanning electron microscope (SEM) image of nitrogen-doped carbon nanoparticle materials, according to an embodiment.

FIG. 16 shows a scanning electron microscope (SEM) image of nitrogen-doped carbon graphitic flakes, according to an embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates to methods of forming solid nitrogen-doped carbon nanotube materials. The method includes one or more process steps, such as mixing a nitrogen-rich feedstock with a carbon feedstock and performing chemical vapor depositions for the one-step production of nitrogen-doped carbon nanotubes. The methods described herein present various benefits over previous methods which would be known to one of ordinary skill in the art, such as ease of preparation, safety of handling, and the integration of a wide variety of nitrogen-based and carbon-based feedstocks. Furthermore, the method disclosed herein exhibits the ability to generate nitrogen-doped carbon nanotubes in-situ in a one-step production process.

In some embodiments, the method is used to produce bespoke carbon nanotubes (CNTs) and other carbon nanomaterials having a carbon-nitrogen composition in the backbone architecture thereof, regardless of the nature and type of the nanomaterials. The method may be integrated to produce one or more of single-walled carbon nanotubes, multiwalled carbon nanotubes, carbon fibers, Buckminsterfullerene molecules carbon fibers, vapour-grown carbon fibers, graphene, nanoribbons, carbon nanofibers, and combinations thereof. In at least one embodiment, the method includes a dry process, wherein the nanomaterials can be used in a purified or non-purified form. In at least one embodiment, the method includes a wet process, wherein the nanomaterials can be used in a purified or non-purified form.

In some embodiments, the method is capable of producing nitrogen-doped carbon nanotubes (N-CNTs), carbon-nitrogen allotropes, carbon-nitrogen nanomaterials, and combinations thereof. In some embodiments, the carbon-nitrogen nanomaterials produced using the method of the present disclosure include additional unbound electrons within the chemical structure of the carbon-nitrogen nanomaterials. The unbound electrons originate from the presence of the nitrogen atoms present within the chemical composition of the nanomaterials. Without being bound by theory, the additional unbound electrons within the chemical structure of the carbon-nitrogen nanomaterials, produced from methods disclosed herein, lend itself to having greater electron density. Such increases in electron density improve the electricity, data, and thermal transport in these materials. The additional electrons can increase the ability to have non-conglomerated samples, a necessary property for homogenous mixtures used in various commercial industries such as composites, automotive, and paints. The additional electrons may also present the ability to make sidewall bonding (e.g., sidewall functionalization) achievable via lower energy pathways, thus making the nanomaterials of the present disclosure more suitable for widespread adoption and application within various commercial industries.

In some embodiments, the method includes mixing a nitrogen-rich feedstock with a carbon-based feedstock to form a feed solution. In at least one embodiment, the feed solution further includes a suitable solvent (e.g., toluene, isopropanol, m-cresol, etc.) to solubilize at least one of the nitrogen-rich feedstock and/or the carbon-based feedstock. In at least one embodiment, the feed solution is substantially free of a solvent. The nitrogen-rich feedstock may include one or more liquid and/or solid nitrogen-containing materials, such as Aniline, Pyridine, Piperidine, Methylamine, Dimethylamine, Ethylamine, Diethylamine, Trimethylamine, Triethylamine, Acetonitrile, N-Methylformamide, N,N-Dimethylformamide (DMF), Formamide, Methacrylamide, N-Methylacetamide, 2-Methylpyridine, N,N-Diethyl-m-toluamide (DEET), 1-Methyl-2-pyrrolidone (NMP), Isoquinoline, Quinoline, Urea, Melamine, Caffeine, Theobromine, Nicotine, Cytosine, Guanine, Adenine, Thymine, Uracil, Tryptophan, Histidine, Lysine, Arginine, Methionine, Asparagine, Glutamine, Biotin, Choline chloride, Para-aminobenzoic acid (PABA), Poly-paraphenylene terephthalamide (e.g., Kevlar), Meta-aramid (e.g., Nomex), Polyacrylonitrile (PAN), Polyurethane (PU), Polypyrrole (PPy), Polyimide, Polyamide (e.g., Nylon 6), Polyamide (e.g., Nylon 6,6), Polyamide (e.g., Nylon 12), Polybenzimidazole (PBI), Polyvinylpyrrolidone (PVP), Polyaniline (PANI), Polyaspartic acid, Poly(ethyleneimine) (PEI), poly(acrylonitrile butadiene styrene) (ABS), derivatives and/or isomers thereof, and combinations thereof. In at least one embodiment, the nitrogen-rich feedstock is present within the feed solution in an amount up to about 20 wt %, such as up to about 10 wt %, such as about 10 wt % to about 20 wt %.

In some embodiments, the carbon-based feedstock can include any carbon-based feed source including plastics, waste plastics, waste solvents, biofuels, paints, refrigerants, polymers, biopolymers, cellulosic materials, cardboard, and various other carbon containing materials. The term waste plastic, as utilized herein, is intended to include material that is unused in industrial manufacturing, post-manufacturing, or post-consumer. Plastics are the general term for a wide range of organic compounds that are malleable and moldable into solid objects. Plastics are typically organic polymers of high molecular mass and often contain other substances such as fillers and color chemicals. In the following description, it is understood that waste plastics may be substituted with waste polymers, paints, waste oils, plastic-coated paper and plastic-coated cardboard, among other carbon containing waste materials. Suitable plastics include, but are not limited to, polyvinyl chloride (PVC), polystyrene (PS), bisphenol A resins, low density polyethylene (LDPE), polypropylene (PP), polymer resins, polyurethane, elastomers, polyolefins, and cellulosic compounds. In at least one embodiment, the carbon-based feedstock is present within the feed solution in an amount of about 80 wt % to about 90 wt %.

In some embodiments, a catalyst may be added to the feed solution to promote the formation of various nitrogen-doped carbon nanomaterials. The term catalyst is used to denote compounds whose decomposition results in the formation of metal species that act as catalysts for the growth of carbon-nitrogen nanomaterials from the feed source. The catalyst is selected based upon the miscibility with the feed source. Suitable catalyst may include, but are not limited to, metallocene molecules such as ferrocene (Fe(CsH₅)₂), cobaltocene (Co(C₅H₅)₂), or nickelocene (Ni(C₅H₅)₂). Additionally, or alternatively, the catalyst can include metal halide compounds such as iron chloride materials (e.g., FeCl₃ and FeCl₂), nickel chloride materials (e.g., NiCl₂), cobalt chloride materials (e.g., CoCl₂), or copper chloride materials (e.g., CuCl₂). Additionally, or alternatively, the catalyst may include metal oxide materials, such as iron oxide materials (e.g., FeO, Fe₂O₃, and Fe₃O₄), nickel oxide materials (e.g., NiO and Ni₂O₃), or cobalt oxide materials (e.g., CoO, Co₂O₃, and Co₃O₄). Additionally, or alternatively, the catalyst may include metal nitrate compounds, including, but not limited to, iron nitrate materials (e.g., Fe(NO₃)₃), cobalt nitrate materials (e.g., Co(NO₃)₂), or nickel nitrate materials (e.g., Ni(NO₃)₂). Additionally, or alternatively, the catalyst may include metal acetylacetonate compounds, such as, but not limited to, iron acetylacetonate (Fe(CsH₇O₂)₃), nickel acetylacetonate (Ni(CsH₇O₂)₂), cobalt acetylacetonate (Co(CsH₇O₂)₂), gallium acetylacetonate (Ga(C₅H₇O₂)₃), or ruthenium acetylacetonate (Ru(C₅H₇O₂)₃). Combinations of catalysts may be utilized. The amount of catalyst in the feed solution, either as a single catalyst or a mixture of catalysts, that is used to obtain nitrogen-doped carbon nanomaterials may be between about 0.0001% and about 50% (w/w) based on the amount of nitrogen-based material and the carbon-based material therein. The amount of catalyst in the feed solution may be between about 0.01% and about 5% (w/w) based on the amount of nitrogen-based material and the carbon-based material therein.

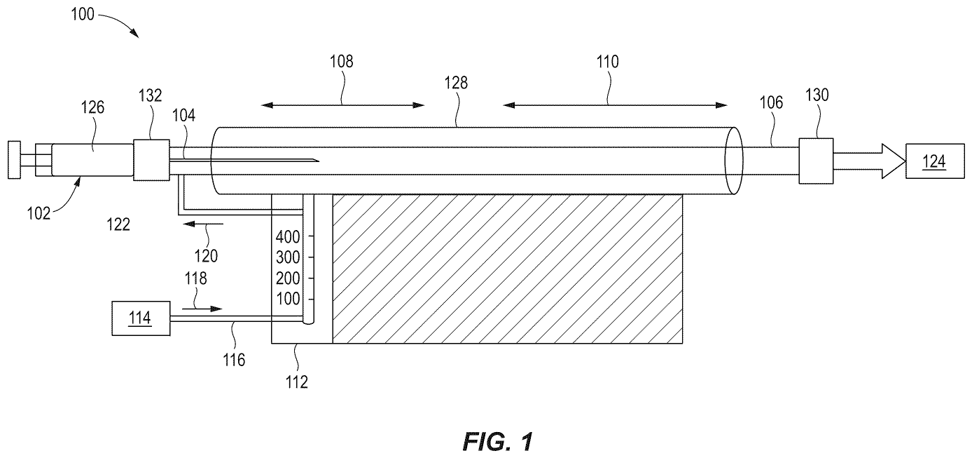

The method further involves injecting the feed solution into a heated reaction vessel at a temperature sufficient to facilitate growth of the nitrogen-doped carbon nanomaterials via a catalytic chemical vapor deposition (c-CVD) technique, such as a liquid injection reactor (LIR). FIG. 1 illustrates a schematic of a reaction vessel 100 according to an embodiment described herein. The reaction vessel 100, such as a LIR, is illustrated as a table top horizontal tube reactor, however it is believed that commercial and industrial scale reactors may be fabricated according to the principles described herein. The reaction vessel 100 includes a separately controlled two-zone furnace 128 having a first zone 108 and a second zone 110. In the first zone 108, the solution of carbon source and catalyst is vaporized. In the second zone 110, the carbon nanomaterials are grown at high temperature. In one embodiment, carbon nanomaterial growth occurs on inside walls of the quartz tube 106 with the second zone 110. In this embodiment, the quartz tube 106 is a substrate for carbon nanomaterial growth. The furnace 128 includes heating coils, for example, 2.2 kW heating coils, capable of maintaining a stable temperature up to 1000° C. for both zones 108, 110 and a PID controller utilized to maintain the temperature within a range of ±0.1° C. from a set temperature.

The reaction vessel 100 also includes a gas flow controller 112. A quartz tube 106 is disposed within the furnace 128 and extends laterally within the furnace 128 such that the furnace surrounds the quartz tube 106. In one embodiment, a length of the quartz tube 106 is between about 500 mm and about 1,000 mm, such as between about 700 mm and about 800, mm, for example, about 760 mm. The quartz tube 106 has an inner diameter of between about 10 mm and about 50 mm, such as between about 30 mm and about 40 mm, for example, about 34 mm.

An injector 102, such as a syringe or the like, is coupled to the quartz tube 106 and in fluid communication with a volume of the quartz tube 106 via a needle 104. The needle 104 is fabricated from a metal, such as stainless steel, of a desired gauge, for example, 20 gauge or 26 gauge with a point style 2. The injector 102, includes a volume 126 which is loaded with the mixture (waste carbon material, solvent, and catalyst precursor). In one embodiment, the injector 102 is a micro pump capable of 0.01 mL/hr injection rate adjustment. In this embodiment, the micro pump injects the mixture through the needle 104 into the quartz tube 106. In another embodiment, a micro pump is utilized to fill the volume 126 of the injector 102 prior to injection of the mixture to the quartz tube 106 The injector 102 is connected to the quartz tube 106 via a first coupling 132 and the needle 104 extends from the injector 102 through the first coupling 132 and into the volume of the quartz tube 106. In one example, the needle 104 extends a distance into the quartz tube 106 corresponding to the first zone 108. As such, the first coupling 132 is disposed adjacent to and may define a terminus of the first zone 108.

A second coupling 130 is connected to the quartz tube 106 opposite the first coupling 132. The second coupling 130 enables connection to an exhaust 124 and the second coupling 130 may define a terminus of the second zone 110. In certain embodiments, both of the first coupling 132 and the second coupling 130 are stainless steel flanges designed as quartz-to-hose type connectors.

A carrier gas source 114 is in fluid communication with the volume of the quartz tube 106. The carrier gas source 114 is coupled to a gas flow controller 112 via a first conduit 116. A second conduit 122 couples the gas flow controller 112 to the volume of the quartz tube 106. A flow path 118 of the carrier gas extends from the carrier gas source 114 to the gas flow controller 112 via the first conduit 116 and a flow path 120 of the carrier gas extends from the gas flow controller 112 to the volume of the quartz tube 106 via the second conduit 122.

In some embodiments, the feed source is injected into a heated reaction vessel, such as the reaction vessel 100, to facilitate growth of the nitrogen-doped carbon nanomaterials via a catalytic chemical vapor deposition (c-CVD) technique. The reaction vessel may be maintained at a temperature between about 100° C. and about 1500° C. In at least one embodiment, the reaction vessel has a first zone and a second zone. In such instances, the first reaction zone is maintained at a temperature between about 250° C. and about 1000° C. and the second reaction zone is maintained at a temperature between about 450° C. and about 1300° C.

In some embodiments, the feed source is injected into the heated reaction vessel with a carrier gas. The carrier gas may include hydrogen diluted in a noble gas such as helium, argon, or can be made of hydrogen diluted with inert gasses such as nitrogen. In at least one embodiment, the carrier gas includes a mixture of hydrogen (e.g., H₂) and nitrogen (e.g., N₂) at a molar ratio of about 0.1:1 to about 1:0.1 hydrogen to nitrogen. In one or more embodiments, the feed source is injected into the heated reaction vessel at a rate flow rate between 1 mL/hr and 10,000 mL/hr under a carrier gas flow rate of about 0.0001 L/min and 10,000 L/min. The resulting nitrogen-doped carbon nanomaterials may then be collected for further processing and/or use. Collection of the nitrogen-doped carbon nanomaterials may be conducted using a cork-screw collection system to enable continuous processing envisioned by the embodiments described herein.

In at least one embodiment, the method disclosed herein produces nitrogen-doped carbon nanomaterials in a yield of about 5% to about 30%. The nitrogen-doped carbon nanomaterials produced by the method disclosed herein include a nitrogen content of about 0.01 mol % to about 1 mol %, as determined by XPS.

In at least one embodiment, the nitrogen-doped carbon nanomaterials are in the form of multi-walled nitrogen-doped carbon nanotubes, single-walled nitrogen-doped carbon nanotubes, vapor grown fibers, Buckminster fullerenes, and/or combinations thereof. The carbon-nitrogen nanomaterials may include an aspect ratio of about 10 to about 500,000.

In at least one embodiment, the nitrogen-doped carbon nanomaterials are nitrogen-doped carbon nanotubes, such as single-walled nitrogen-doped carbon nanotubes, multi-walled nitrogen-doped carbon nanotubes, or combinations thereof. The nitrogen-doped carbon nanotubes can include an average aspect ratio of about 10 to about 500,000. The nitrogen-doped carbon nanotubes can include an average nitrogen content of about 0.01 mol % to about 10 mol %. The nitrogen-doped carbon nanotubes can include an average nanotube length of about 10 nm to about 100 mm. The nitrogen-doped carbon nanotubes can include an average inner tube diameter of about 1 nm to about 100 nm. The carbon-nitrogen nanotubes can include an average outer-tube diameter of about 1 nm to about 100 nm.

In at least one embodiment, a carbon-nitrogen nanomaterial is a nitrogen doped carbon nanotube, such as a single-walled carbon nitrogen nanotube or a multi-walled carbon nanotube. A carbon-nitrogen nanotube can include an aspect ratio of about 10 to about 500,000. A carbon-nitrogen nanotube can include a nitrogen content of about 0.01 mol % to about 1 mol %. A carbon-nitrogen nanotube can include a nanotube length of about 10 nm to about 500,000 mm. A carbon-nitrogen nanotube can include an inner tube diameter of about 1 nm to about 100 nm. A carbon-nitrogen nanotube can include an outer-tube diameter of about 1 nm to about 100 nm. It should be noted that a carbon-nitrogen nanomaterial of the present disclosure is not restricted to any one or more size constraints, and that there is no limitation to the degree of nitrogen content within the carbon nanomaterial chemical structure.

Because processes of the present disclosure can be solvent-free (e.g., substantially free of solvent), the process is highly suitable for rapid formation of electrical cables, enabling use of minimal energy and work to create electrical cables. As such, methods of the present disclosure can be performed as a continuous process. This allows for rapid production of nitrogen-doped carbon nanomaterials at high production volumes. In at least one embodiment, the methods disclosed herein can be used to produce carbon nanomaterials, such as nitrogen-doped carbon nanomaterials, at a production rate of about 0.001 mg/hr to about to about 1 kg/hr.

### EXAMPLES

### Example 1

A feed solution was prepared and loaded into a Luer-lock tip style 10 ml syringe. The syringe was fitted with a 16-gauge, 10-inch, SS-304 syringe needle and positioned in a syringe pump to maintain a constant reactant inlet flow rate. Each solution was subjected to at least three growth trials to ensure reproducibility of the observed trends. Each of the feed solutions prepared implemented the same amounts of carbon-based feed material and catalyst. The feed solutions differed in the amount of nitrogen-rich feedstock integrated therein, wherein: (A) a first feed solution includes 0 wt % of the nitrogen-rich feedstock, (B) a second feed solution includes 5 wt % of the nitrogen-rich feedstock, and (C) a third feed solution includes 10 wt % of nitrogen-rich feedstock.

### Example 2

Carbonaceous nanomaterials were synthesized utilizing a catalytic chemical vapor deposition (c-CVD) technique within a two-zone horizontal tube reactor equipped with a liquid injection reactor (LIR). The synthesis process involved injecting a 10 mL feed solution (e.g., the feed solutions prepare in Example 1) at a variety of rates between 1 mL/hr and 10,000 mL/hr under a constant carrier gas flow of between 0.0001 L/hr and 10,000 L/min, employing a specific ratio of hydrogen to nitrogen. The reactor's first zone, designated for vapor formation, was maintained between 250° C. and 1000° C. The second zone, intended for growth, was set at 450° C. and 1,300° C. Multi-walled carbon nanotubes (MWCNTs) were synthesized in an inert tube with an inner diameter of between 10 mm and 10,000 mm. The reaction compositions and results thereof (e.g., yield of nanomaterial products) are summarized in Table 1.

TABLE 1
Summary of reaction compositions
of Example 2 and results thereof.

| | Total mass of | | | | | | |
|---|---|---|---|---|---|---|---|
| Solids | nitrogen-rich | | | | | | |
| nitrogen | and carbon- | | | | | | |
| feedstock | based feed in | LIR Product mass (g) | | | | Yield (%) | |
| loading % | feed solution | | | Aver- | ST. | Aver- | |
| (w/w) | (g) | MIN | MAX | age | DEV. | age | Best |
| 0 | 8.29 | 0.95 | 1.22 | 1.09 | 0.11 | 11 | 12 |
| 5 | 8.69 | 1.21 | 1.58 | 1.34 | 0.14 | 15 | 18 |
| 10 | 9.13 | 0.63 | 1.32 | 1.05 | 0.26 | 11 | 14 |

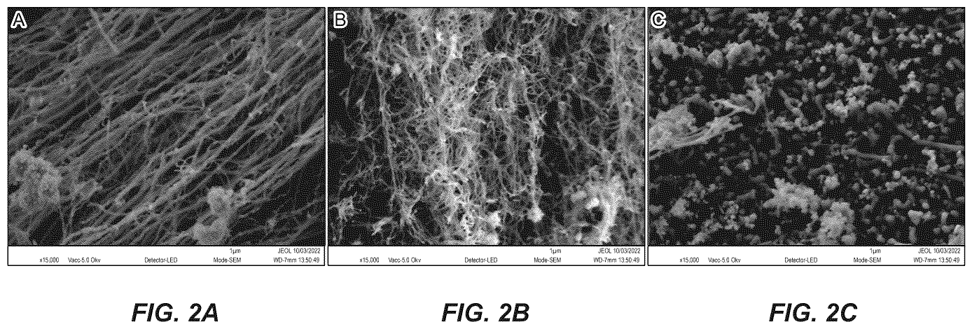

FIGS. 2A-2C are scanning electron microscope (SEM) images (magnification 40,000×) of nitrogen-doped carbon nanomaterials produced according to one or more embodiments described herein. The images of FIGS. 2A-2C are from materials produced according to example 2 described in greater detail hereinafter. The image was taken by JEOL 7800 FEG SEM at 5 kV and a probe current of 6 pA. Copper sticky tape was used as the base. A diameter of CNTs formed by the methods described herein were measured by analyzing the distances in ImageJ. As can be observed in FIG. 2A, carbon nanomaterials produced using a feed solution absent a nitrogen-rich feedstock (e.g., sample A as described in example 1) result in long, straight carbon nanomaterials of limited entanglement. Furthermore, numerous catalyst nanoparticles can be observed in the carbon nanomaterial products when using sample A as the feed solution. As can be observed in FIG. 2B, the nitrogen-doped carbon nanomaterials produced using sample B (e.g., sample B as described in example 1) as the feed solution result in long and entangled nitrogen-doped carbon nanomaterials. As can be observed in FIG. 2C, the nitrogen-doped carbon nanomaterials produced using sample C (e.g., sample C as described in example 1) as the feed solution result in nitrogen-doped carbon nanomaterials with a mix of high and low aspect ratio (AR) carbonaceous nanomaterials and iron nanoparticle agglomerates.

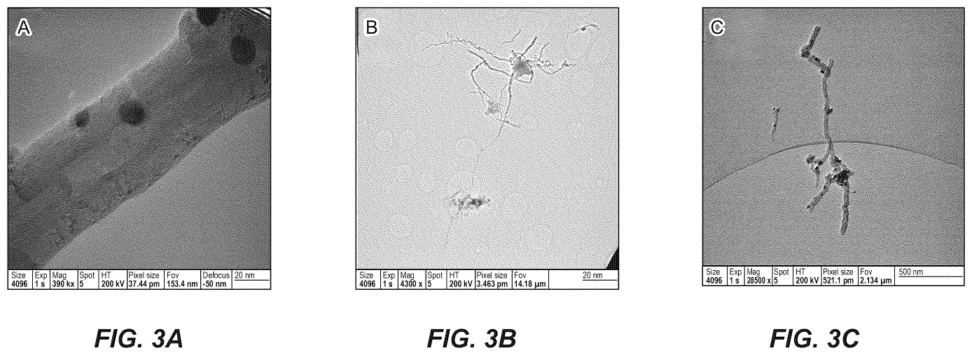

FIGS. 3A-3C are transmission electron microscope (TEM) images of nitrogen-doped carbon nanomaterials produced according to one or more embodiments described herein. The images of FIGS. 3A-3C are from materials produced according to example 2 using sample A as the feed solution. Each of the respective images show a representative image of the carbon nanomaterials produced therefrom having (A) the highest number of walls, (B) the longest tube, and (C) fewest possible number of walls.

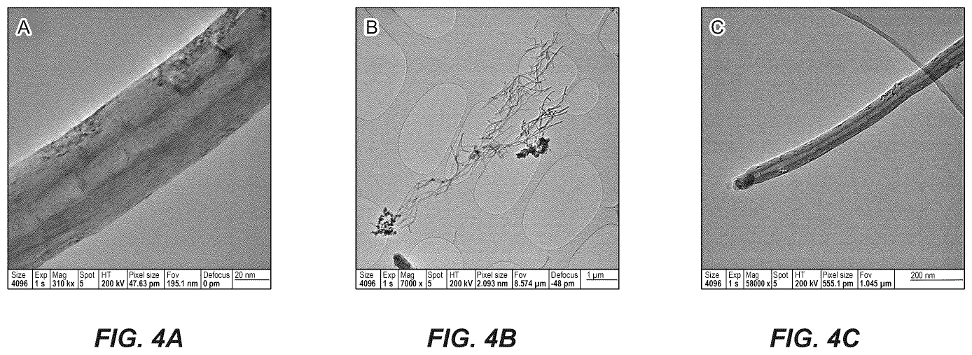

FIGS. 4A-4C are TEM images of nitrogen-doped carbon nanomaterials produced according to one or more embodiments described herein. The images of FIGS. 4A-4C are from materials produced according to example 2 using sample B as the feed solution. Each of the respective images show a representative image of the carbon nanomaterials produced therefrom having (A) the highest number of walls, (B) the longest tube, and (C) a membrane-like nanomaterial.

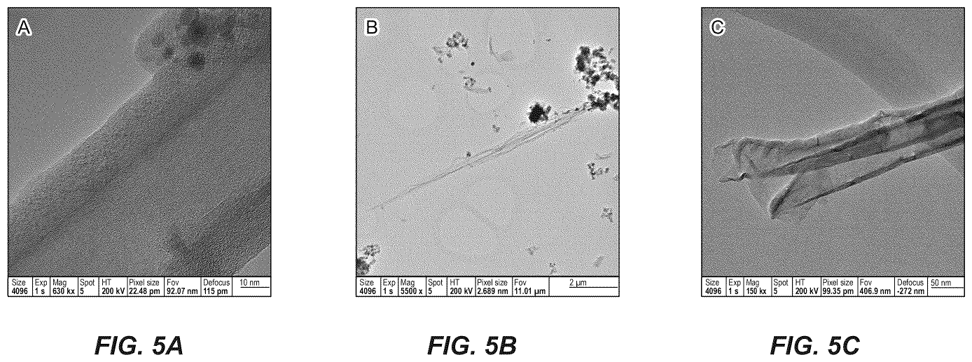

FIGS. 5A-5C are TEM images of nitrogen-doped carbon nanomaterials produced according to one or more embodiments described herein. The images of FIGS. 5A-5C are from materials produced according to example 2 using sample C as the feed solution. Each of the respective images show a representative image of the carbon nanomaterials produced therefrom having (A) the highest number of walls, (B) the longest tube, and (C) a nanomaterial free of metal catalyst nanoparticles.

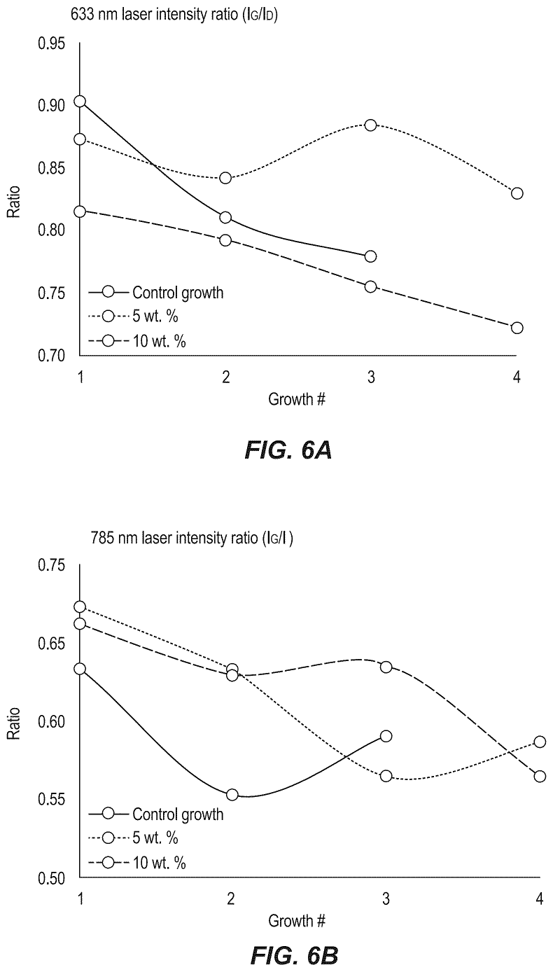

FIGS. 6A-6B shows various intensity ratio peaks of all growths at different nitrogen feedstock concentration. The values for each of the peaks and intensity ratios are summarized in Table 2.

TABLE 2
Summary of peak position and intensity ratio (IG/ID)
calculated from the average data of each growth
set at 633 and 785 nm Raman laser wavelengths.

| 633 nm wavelength laser | | | | 785 nm wavelength laser | | | |
|---|---|---|---|---|---|---|---|
| solids | | | | solids | | | |
| nitrogen | | | | nitrogen | | | |
| feedstock | | | | feedstock | | | |
| wt % | D | G | I_{G}/I_{D} | wt % | D | G | I_{G}/I_{D} |
| 0 | 1333 | 1586 | 0.82 | 0 | 1308 | 1601 | 0.59 |
| 5 | 1329 | 1589 | 0.85 | 5 | 1310 | 1588 | 0.61 |
| 10 | 1329 | 1587 | 0.78 | 10 | 1310 | 1588 | 0.63 |

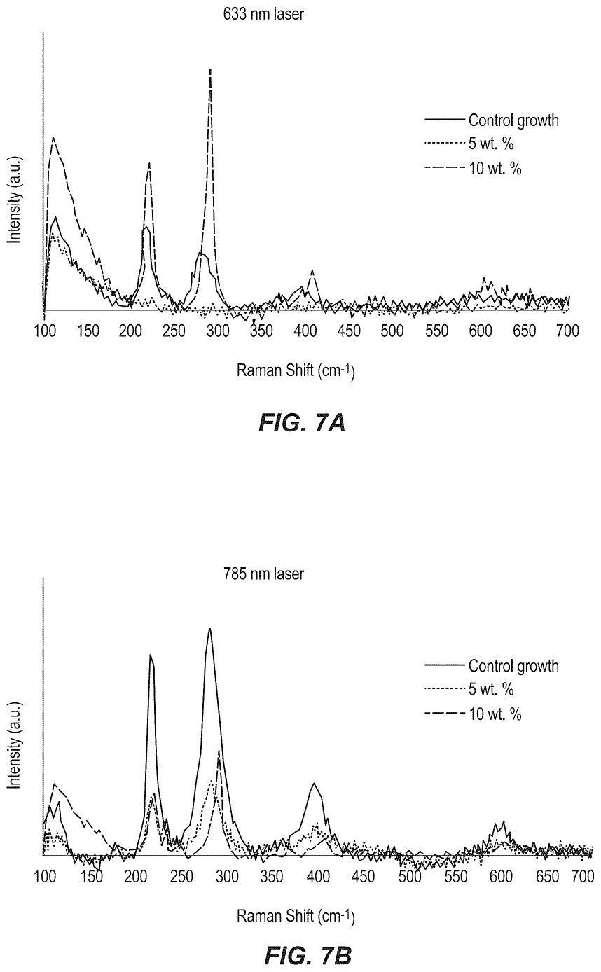

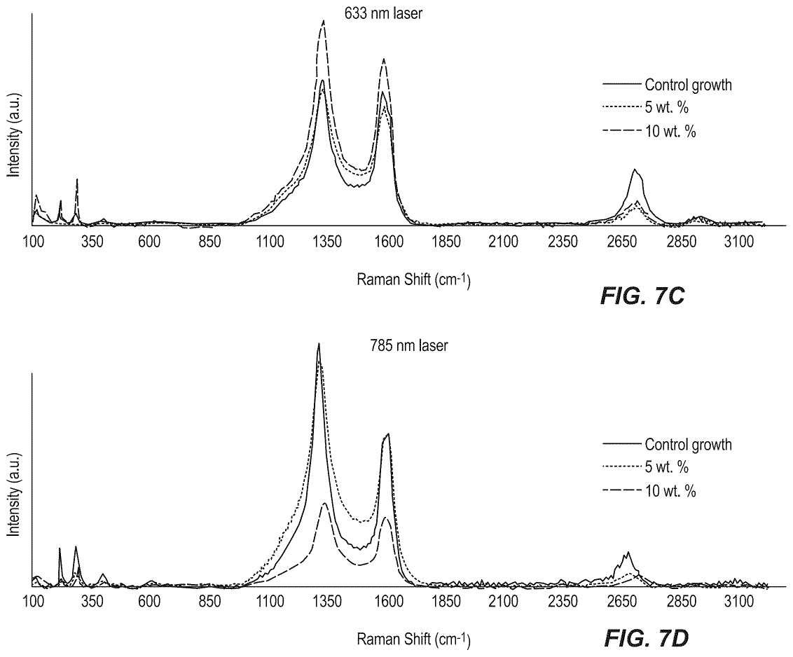

FIGS. 7A-7D are graphs illustrating Raman spectra of the nanomaterials formed using the method of Example 2 and samples A-C as the feed solutions. The Raman spectrum was acquired in an inVia confocal Renishaw Raman instrument using a 785 nm and/or a 633 nm wavelength laser, an exposure time of 10 seconds, and laser power of 0.5%. The peak position results of the Raman spectrum for each laser wavelength are summarized in Table 3.

TABLE 3
Peak positions of nanomaterial samples for each
feed solution at varying laser intensities.

| 0 wt % solids | | 5 wt % solids | | 10 wt % solids | |
|---|---|---|---|---|---|
| nitrogen feedstock | | nitrogen feedstock | | nitrogen feedstock | |
| 633 nm | 785 nm | 633 nm | 785 nm | 633 nm | 785 nm |
| 114 | 116 | 111 | 107 | 111 | 107 |
| 219 | 218 | N/A | 218 | 221 | 221 |
| 281 | 283 | N/A | 283 | 291 | 283 |
| 1329 | 1306 | 1327 | 1309 | 1334 | 1306 |
| 1586 | 1600 | 1589 | 1596 | 1587 | 1585 |
| 2652 | 2606 | 2660 | 2610 | 2662 | 2610 |
| 2920 | 3053 | N/A | N/A | 2906 | 3053 |

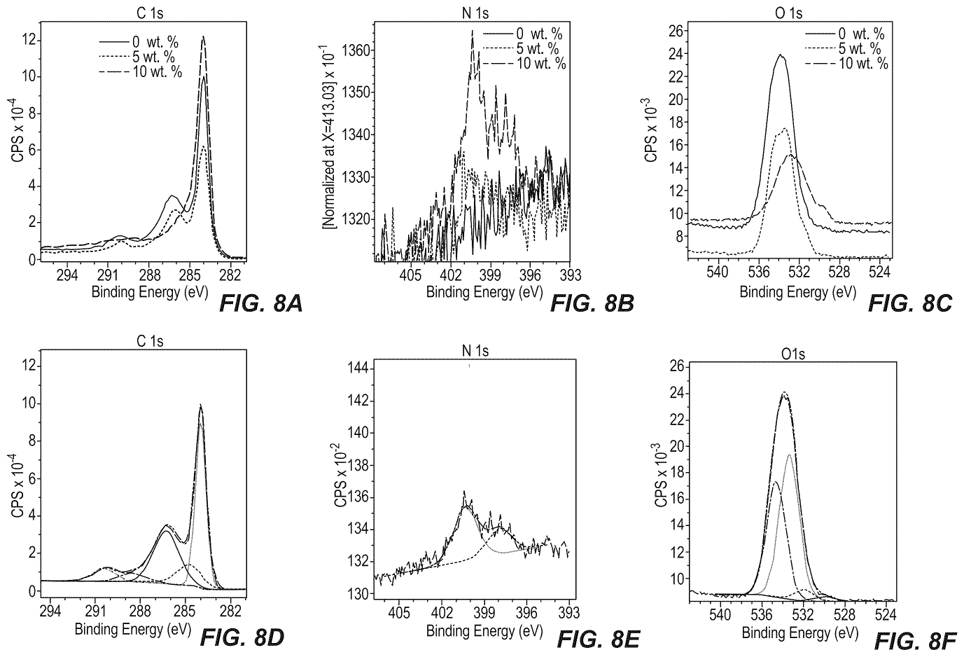

FIGS. 8A-8F shows the deconvoluted N 1s, C 1s, and O 1s spectra of the produced nanomaterials as well as for some of their functional groups for each nitrogen feedstock loading. The results of the compositional analysis are summarized in Table 4.

TABLE 4
Compositional analysis of nanomaterial
samples for each feed solution.

| Solids | | | | | | |
|---|---|---|---|---|---|---|
| nitrogen | | | | | | |
| feedstock | | | | | | D- |
| wt % | Carbon | Iron | Nitrogen | Oxygen | Silicon | parameter |
| 10 | 90.0 | 0.26 | 0.26 | 6.9 | 2.5 | 18.8 |
| | 97.0 | 0.27 | 0.29 | 2.3 | 0.1 | 20.5 |
| | 95.2 | 0.14 | 0.22 | 4.2 | 0.3 | 20.2 |
| | 94.1 | 0.22 | 0.26 | 4.45 | 0.99 | 19.8 |
| 5 | 94.0 | 0.05 | 0.09 | 5.5 | 0.4 | 20.4 |
| | 88.3 | 0.09 | 0.08 | 10.9 | 0.7 | 16.8 |
| | 90.5 | 0.07 | 0.13 | 8.7 | 0.6 | 17.8 |
| | 90.9 | 0.07 | 0.10 | 8.35 | 0.55 | 18.3 |
| 0 | 90.6 | 0.15 | 0.00 | 8.7 | 0.6 | 17.9 |
| | 87.1 | 0.10 | 0.00 | 11.6 | 1.2 | 16.5 |
| | 90.5 | 0.08 | 0.00 | 8.8 | 0.6 | 17.9 |
| | 89.4 | 0.11 | 0.00 | 9.70 | 0.81 | 17.4 |

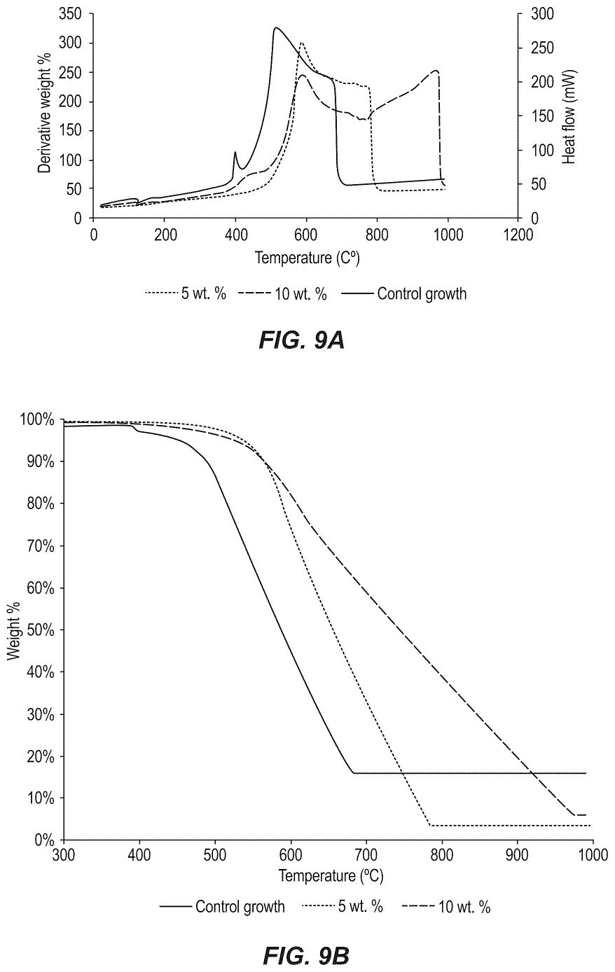

FIG. 9A-9B are graphs illustrating the thermogravimetric analysis (TGA) of the nanomaterials formed using samples A-C as the feed solutions. TGA was carried out in a TA Instruments SDT Q600 TGA instrument. CNT samples were made as described in example 11 discussed in greater detail hereinafter. 5 mg of CNT sample was placed in an alumina cup and TGA was run under 100 mL/min air flow. Two ramping stage were applied. First, the sample was heated up to 400° C. ramping at 20° C./min. Then the ramping rate was decreased to 5° C./min and the temperature was increased to 750° C. so that all the carbon species were burned and iron oxide was left. The TGA chamber was cooled down to room temperature running 5 mL/min argon therethrough. The weight loss (directly interpreted as carbon content of the sample; shown in FIG. 9A), first derivative weight percent (shown in FIG. 9B), and the lowest temperature at which the weight loss started were among the data acquired. The difference in thermal degradation behavior for each of the materials is indicative of compositionally unique, which can be attributed to the difference of nitrogen content in each of the respective feed solutions.

### Example 3

In a series of production runs using samples with nitrogen feedstock of between 0 wt % and 20 wt % without a catalyst, dissolved in toluene were prepared by the method described in example 2 and imaged under the SEM. Additionally, a dry run was performed without the catalyst in the LIR to observe if the heat and gases alone could alter the nitrogen feedstock, potentially contributing to the unidentified elements observed in the SEM images. This approach ensured a thorough investigation of the origins of the brighter elements.

### Example 4

Carbonaceous nanomaterials were synthesized utilizing a catalytic chemical vapor deposition (c-CVD) technique within a two-zone horizontal tube reactor equipped with a piece of liquid injection machinery. The synthesis process involved injecting a 10 mL solution at a variety of rates between 1 mL/hr and 10,000 mL/hr under a constant gas flow of between 0.0001 L/min and 10,000 L/min, employing a bespoke ratio of hydrogen to nitrogen gas such that the reaction be controlled to make carbon fibres. The reactor's first zone, designated for vapor formation, was maintained between 250° C. and 1000° C. The second zone, intended for growth, was set at 450° C. and 1,300° C. Hollow carbon fibres were formed within the inert tube with an inner diameter of between 10 mm and 10,000 mm.

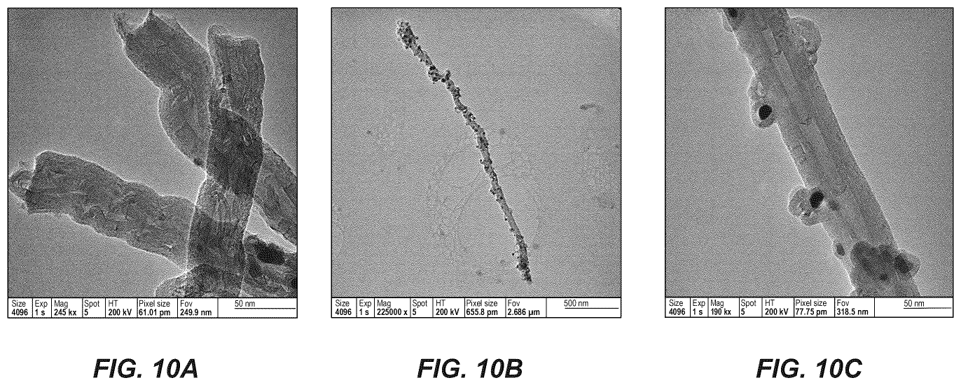

FIGS. 10A-10C are TEM images of carbon nanofibers produced according to one or more embodiments described herein. The images of FIGS. 10A-10C are from materials produced according to example 4 using sample A as the feed solution. Each of the respective images show a representative image of the carbon nanomaterials produced therefrom having (A) carbon nanofibers free of iron particles, and (B)-(C) iron particles on the walls of the carbon nanofibers.

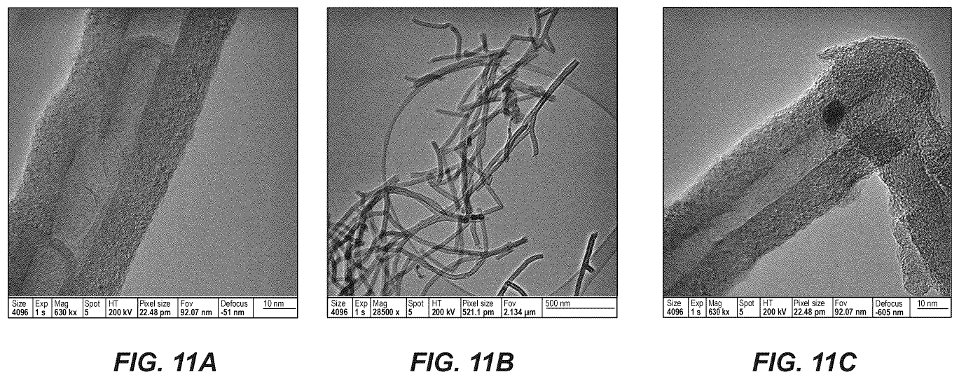

FIGS. 11A-11C are TEM images of nitrogen-doped carbon nanofibers produced according to one or more embodiments described herein. The images of FIGS. 11A-11C are from materials produced according to example 4 using sample B as the feed solution. Each of the respective images show a representative image of the carbon nanomaterials produced therefrom having (A) a membrane-like structure, (B) a limited presence of iron nanoparticles on the walls of the nitrogen-doped carbon nanofibers, and (C) two nitrogen-doped carbon nanofibers welded together.

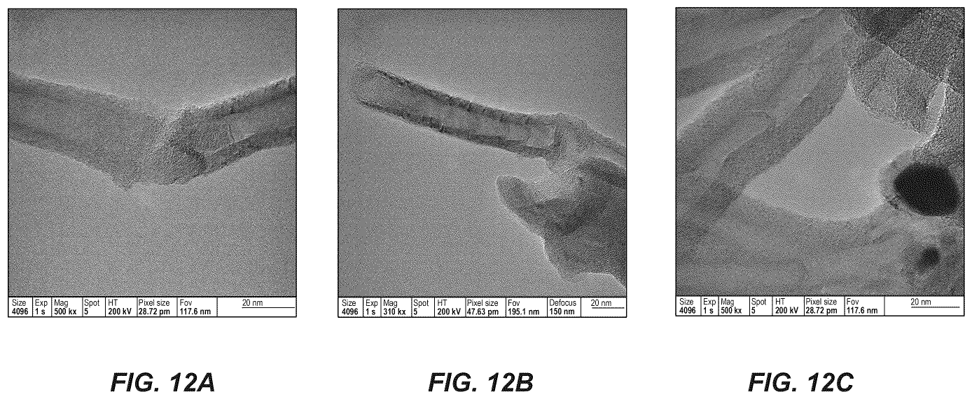

FIGS. 12A-12C are TEM images of nitrogen-doped carbon nanofibers produced according to one or more embodiments described herein. The images of FIGS. 12A-12C are from materials produced according to example 4 using sample C as the feed solution. Each of the respective images show a representative image of the carbon nanomaterials produced therefrom having (A) two nitrogen-doped carbon nanofibers welded together, (B) a metal-free end of a nanofiber, and (C) various junctions of nitrogen-doped carbon nanofibers.

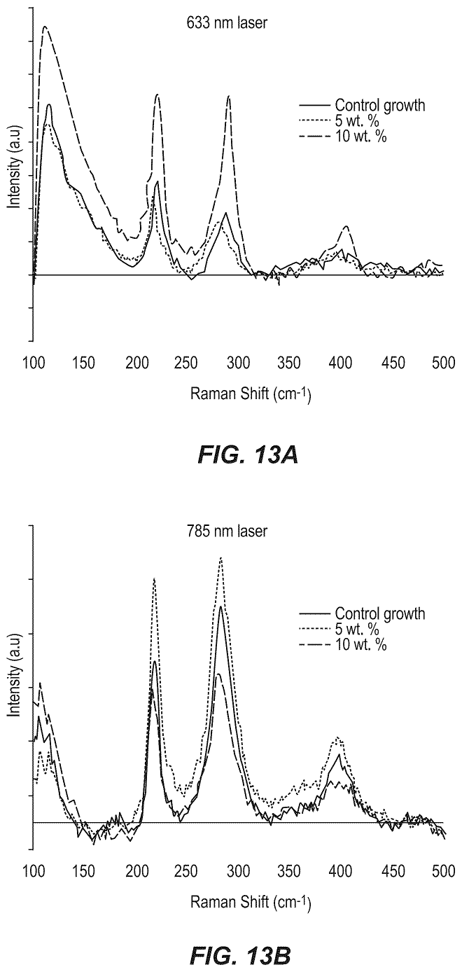

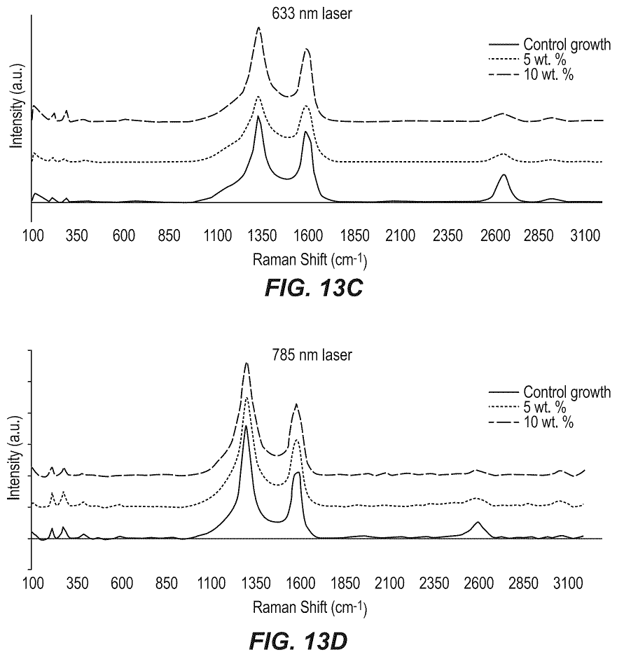

FIGS. 13A-13D are graphs illustrating Raman spectra of the nanomaterials formed using the method of Example 4 and samples A-C as the feed solutions. The Raman spectrum was acquired in an inVia confocal Renishaw Raman instrument using a 785 nm and/or a 633 nm wavelength laser, an exposure time of 10 seconds, and laser power of 0.5%.

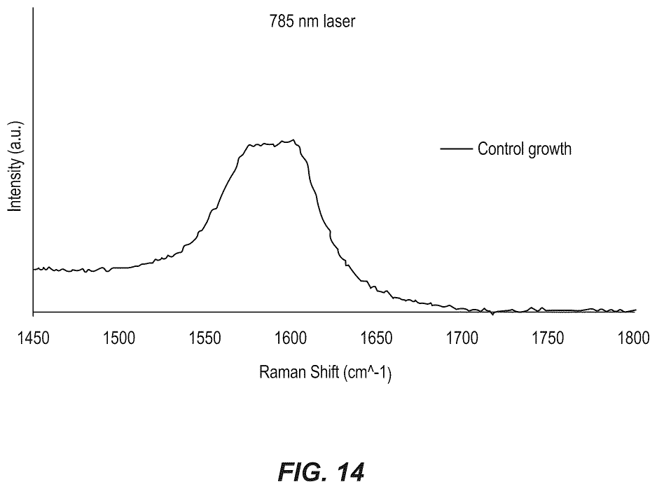

FIG. 14 shows Raman spectra of the G band split at the average plot of control growth (showing an average of 3 growths) that verifies the nanomaterials are metallic in nature.

### Example 5

Following Example 1, a nitrogen-doped carbon nanomaterial Buckypaper is created by using materials derived from numerous growth conditions are mechanically processed using a laboratory bead mill to achieve a fine dispersion. This dispersion is then mixed into solvent such as toluene, isopropanol and m-cresol to achieve a concentration of between 0.01 and 10,000 mg/mL. To ensure uniformity of the solution, each sample undergoes ultrasonication treatment using a probe sonicator for two hours at an amplitude setting of between 0.01% and 100%, employing a pulse sequence of between 0.01 and 100 seconds on followed by a pause lasting between 0.001 and 100,000 seconds. Subsequent to sonication, the solution is subjected to vacuum filtration and the retentate is washed with acetone, isopropanol, ethanol, and nitric acid to facilitate cleaning. The retentate obtained through this process demonstrates a less condensed structure than conventional buckypaper, showing a tendency to disintegrate more readily. Furthermore, the black coloration of the filtrate indicates the presence of carbon soot, suggesting that some carbon material passes through the filter.

### Example 6

Following from Example 5, the filtration was conducted using filter paper with a pore size of 8 micrometers, which exceeds the optimal less than 2 micrometers typically required for effective buckypaper fabrication.

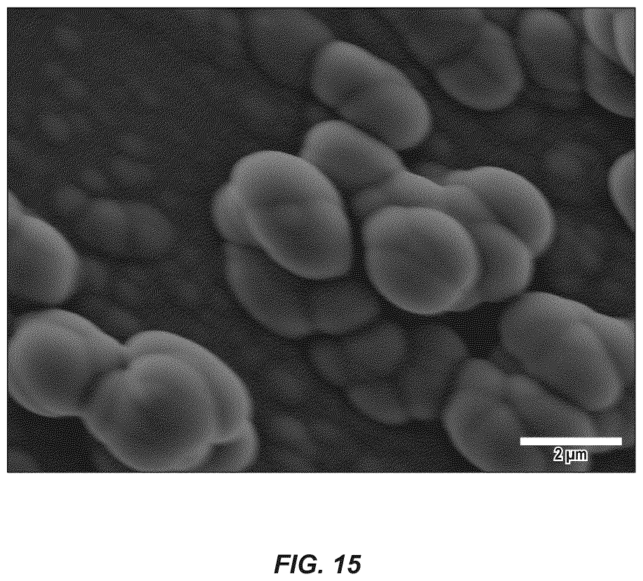

FIG. 15 shows an SEM image of nanoparticle structures composed of carbon-nitrogen materials resulting from the method of Example 5.

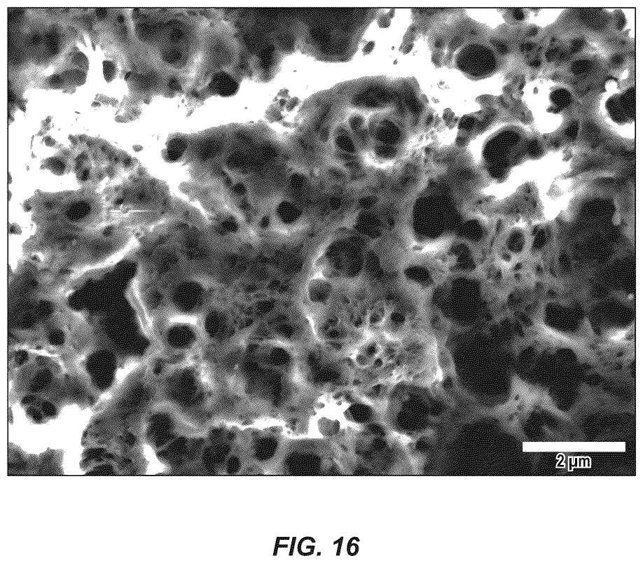

FIG. 16 shows an SEM image of graphitic flakes composed of nitrogen-doped carbon materials resulting from the method of Example 5.

Overall, the present disclosure provides a method for preparing high volumes of carbon-nitrogen nanomaterials. The method involves the use of a solid and/or liquid feedstocks that are mixed in one or more steps to form a feed solution. The feed solution can then be heated to induce a reaction via a chemical vapor deposition process to form the nitrogen-doped carbon nanomaterials. The method disclosed herein enables an in-situ formation process to convert carbon and nitrogen feedstocks into nitrogen-doped carbon nanomaterials (e.g., nanotube powders) in a batch or continuous chemical process. The nanomaterials produced via the method disclosed herein may be used to produce multi-walled nitrogen-doped nanotubes, single-walled nitrogen doped nanotubes, vapor grown fibers, Buckminster fullerenes, and/or combinations thereof. Furthermore, the present method can allow for the use of other non-carbon nanomaterials to be added in addition to or without the presence of the carbon nanomaterials. Additionally, the method disclosed herein may be formulated to be partially free of solvents, such as completely solvent free. Such reductions and/or elimination of solvent requirements make the method of the present disclosure highly suitable for rapid formation of electrical wiring. That is to say, the method described herein may be useful in the rapid formation of electrical wires. This can be done in a continuous process directly as nanotubes are manufactured.

Certain embodiments of this disclosure are not limited to any particular individual feature disclosed here but include combinations of them distinguished from the prior art in their structures, functions, and/or results achieved. Features of the disclosure have been broadly described so that the detailed descriptions that follow may be better understood, and in order that the contributions of this invention to the arts may be better appreciated.

There are, of course, additional aspects of the disclosure described below, and which may be included in the subject matter of the claims to this disclosure. Those skilled in the art who have the benefit of this disclosure, its teachings, and suggestions will appreciate that the conceptions of this disclosure may be used as a creative basis for designing other structures, methods and systems for carrying out and practicing the methods described herein. The claims of this disclosure are to be read to include any legally equivalent devices or methods, which do not depart from the spirit and scope of the present disclosure. The present disclosure and its diverse embodiments recognize and address the long-felt needs and provides a solution to problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later disguise it by variations in form, changes, or additions of further improvements.

It will be understood that the various embodiments of the present disclosure may include one, some, or any possible combination of the disclosed, described, and/or enumerated features, aspects, and/or improvements and/or technical advantages and/or elements in claims to this disclosure.

As can be easily understood from the foregoing, the basic concepts of the present invention may be embodied in a variety of ways. It involves structures, method steps, and techniques as well as devices to accomplish the appropriate ends. Techniques and method steps according to the present invention are disclosed as part of the results shown to be achieved by the various devices and structures and described as steps, which are inherent to utilization and are simply the natural result of utilizing the devices and structures as intended and described. In addition, while some devices and structures are disclosed, it should be understood that these not only accomplish certain methods but also can be varied in a number of ways. As to all of the foregoing, all of these facets should be understood as encompassed by this disclosure.

While the foregoing is directed to embodiments of the present disclosure, other and further embodiments of the disclosure may be devised without departing from the basic scope thereof, and the scope thereof is determined by the claims that follow.

1. A method for forming carbon-nitrogen nanomaterials, the method comprising:
mixing a nitrogen-rich feedstock, carbon-based feedstock, and a catalyst to form a feed solution;
injecting the feed solution into a carrier gas stream and into a heated reaction vessel, the heated reaction vessel comprising a first zone and a second zone;
heating the feed solution within the first zone at a first temperature;
heating the feed solution within the second zone at a second temperature to form the carbon-nitrogen nanomaterials; and
removing the carbon-nitrogen nanomaterials from the heated reaction vessel.

2. The method of claim 1, wherein the nitrogen-rich feedstock comprises a liquid nitrogen-containing compound, a solid nitrogen-containing compound, or a combination thereof.

3. The method of claim 1, wherein the nitrogen-rich feedstock comprises a compound selected from the group consisting of aniline, pyridine, piperidine, methylamine, dimethylamine, ethylamine, diethylamine, trimethylamine, triethylamine, acetonitrile, N-methylformamide, N,N-dimethylformamide, formamide, methacrylamide, N-methylacetamide, 2-methylpyridine, N,N-diethyl-m-toluamide, 1-methyl-2-pyrrolidone, isoquinoline, quinoline, urea, melamine, caffeine, theobromine, nicotine, cytosine, guanine, adenine, thymine, uracil, tryptophan, histidine, lysine, arginine, methionine, asparagine, glutamine, biotin, choline chloride, para-aminobenzoic acid, poly-paraphenylene terephthalamide, meta-aramid, polyacrylonitrile, polyurethane, polypyrrole, polyimides, Nylon 6, Nylon 6,6, Nylon 12, polybenzimidazole, polyvinylpyrrolidone, polyaniline, polyaspartic acid, poly(ethyleneimine), poly(acrylonitrile butadiene styrene), derivatives and/or isomers thereof, and combinations thereof.

4. The method of claim 1, wherein the feed solution comprises about 0.01 wt % to about 20 wt % of the nitrogen-rich feedstock.

5. The method of claim 1, wherein the feed solution comprises about 80 wt % to about 90 wt % of the carbon-based feedstock.

6. The method of claim 1, wherein the feed solution comprises about 0.0001% and about 50% (w/w) based on an amount of the nitrogen-rich feedstock and the carbon-based feedstock therein.

7. The method of claim 1, wherein the carrier gas stream comprises a mixture of hydrogen and nitrogen.

8. The method of claim 1, wherein the carbon-nitrogen nanomaterials comprise a structure selected from the group consisting of multi-walled carbon-nitrogen nanotubes, single-walled carbon-nitrogen nanotubes, vapor grown fibers, Buckminster fullerenes, and combinations thereof.

9. A method for forming a carbon-nitrogen nanomaterial, the method comprising:
mixing a nitrogen-rich feedstock, carbon-based feedstock, and a catalyst to form a feed solution, wherein the feed solution is comprised of about 0.01 wt % to about 20 wt % of the nitrogen-rich feedstock;
injecting the feed solution into a carrier gas stream and into a heated reaction vessel, the heated reaction vessel comprising a first zone and a second zone, the carrier gas stream comprising a mixture of hydrogen and nitrogen in a molar ratio of about 0.1:1 to about 1:0.1;
heating the feed solution within the first zone at a first temperature;
heating the feed solution within the second zone at a second temperature to form the carbon-nitrogen nanomaterial; and
removing the carbon-nitrogen nanomaterial from the heated reaction vessel.

10. The method of claim 9, wherein the carbon-nitrogen nanomaterial comprises a nitrogen content of about 0.01 mol % to about 1 mol %.

11. The method of claim 9, wherein the carbon-nitrogen nanomaterial comprises an aspect ratio of about 10 to about 10,000.

12. The method of claim 9, wherein the carbon-nitrogen nanomaterial comprises a nanotube structure selected from a single-walled nanotube or a multi-walled nanotube.

13. The method of claim 12, wherein the carbon-nitrogen nanomaterial comprises:
a tube length of about 10 nm to about 1 mm;
an inner diameter of about 1 nm to about 100 nm; and
an outer diameter of about 1 nm to about 100 nm.

14. The method of claim 9, wherein the carbon-nitrogen nanomaterial comprises a plurality of carbon-nitrogen nanomaterials.

15. The method of claim 14, wherein the carbon-nitrogen nanomaterial comprises an average aspect ratio of about 10 to about 500,000.

16. The method of claim 14, wherein the plurality of carbon-nitrogen nanomaterials comprises an average nitrogen content of about 0.01 mol % to about 1 mol %.

17. A continuous reaction method for forming nitrogen-doped carbon nanomaterials, the method comprising:
mixing a nitrogen-rich feedstock, carbon-based feedstock, and a catalyst to form a feed solution, the feed solution comprising of about 0.01 wt % to about 20 wt % of the nitrogen-rich feedstock, wherein the feed solution is substantially free of solvent;
injecting the feed solution into a carrier gas stream and into a heated reaction vessel, the heated reaction vessel comprising a first zone and a second zone;
heating the feed solution within the first zone at a first temperature;
heating the feed solution within the second zone at a second temperature to form the nitrogen-doped carbon nanomaterials; and
removing the nitrogen-doped carbon nanomaterials from the heated reaction vessel.

18. The method of claim 17, wherein the nitrogen-doped carbon nanomaterials are produced at a production rate of about 0.001 mg/hr to about to about 1 kg/hr.

19. The method of claim 18, wherein the nitrogen-doped carbon nanomaterials comprise an average nitrogen content of about 0.01 mol % to about 1 mol %.

20. The method of claim 17, wherein the nitrogen-doped carbon nanomaterials comprise:
a tube length of about 10 nm to about 1 mm;
an inner diameter of about 1 nm to about 100 nm; and
an outer diameter of about 1 nm to about 100 nm.
